(19) United States
(12) Patent Application Publication
(10) Pub. No.: US 2022/0076317 A1
(43) Pub. Date: Mar. 10, 2022

(54) METHOD, SERVER, AND PROGRAM FOR MEASURING BODY SIZE AND RECOMMENDING CLOTHING SIZE BY USING IMAGE

(71) Applicant: IDICTION CO., LTD., Daejeon (KR)

(72) Inventor: Jaemin YANG, Daejeon (KR)

(21) Appl. No.: 17/417,740

(22) PCT Filed: Dec. 26, 2019
(86) PCT No.: PCT/KR2019/018494

§ 371 Date: Jun. 23, 2021

(30) Foreign Application Priority Data
Jan. 3, 2019 (KR) 10-2019-0000925
Nov. 29, 2019 (KR) 10-2019-0157816

(51) Int. Cl. G06Q 30/06; G06K 9/00; G06K 9/20; G06K 9/46; G06T 7/194; G06K 9/62; G06T 19/20; H04N 5/232; G06T 7/13; G06T 7/60; G06N 20/00

(52) U.S. Cl. CPC G06Q 30/0631; G06T 2219/2016; G06K 9/2063; G06K 9/4604; G06T 7/194; G06K 9/6256; G06T 19/20; H04N 5/23222; G06T 7/13; G06K 9/00664; G06T 7/60; G06N 20/00; G06T 2207/20081; G06T 2207/30196; G06T 2219/2021; G06K 9/00369

(57) ABSTRACT

The present invention relates to a method for measuring a body size and recommending a clothing size by using an image, and provides a user's body size to a custom clothing manufacturer, so that custom clothing can be manufactured with accurate dimensions, and provides a constructed body size measurement model to an outline store, such that when a user selects a specific garment, a size that exactly fits the user's body is recommended.

### FIELD OF INVENTION

The present invention relates to a method of measuring a body size and manufacturing customized clothes based on an image of a user, and recommending a clothes size in an online shopping mall using the image.

### BACKGROUND OF INVENTION

Conventionally, most people visit offline stores and try on clothes before purchasing, and thus clothes of the wrong size are rarely chosen.

However, in recent years, the number of people purchasing clothes through online shopping has increased rapidly, and in this case, the size of the clothes is often wrong.

An increasing number of companies are disclosing the actual size of clothes along with photos of clothes, but there is a problem in that consumers are not capable of knowing exactly their detailed body size.

Needless to say, most people know their body size, such as their weight and height, but there is a problem that it is difficult to purchase clothes online with only these two pieces of information.

Therefore, there is a need for a method of measuring an exact body size of a user in order to implement technology for virtual wearing thorough comparison with an actual size of clothes.

### SUMMARY OF INVENTION

### Technical Problem to be Solved

According to the present invention, a body size of a user may be measured from an image of the user, captured from a user terminal.

According to the present invention, the measured body size of the user may be provided to a manufacturer of customized clothes ordered by the user.

According to the present invention, information on a fitting or basting result of customized clothes of a user may be received from a customized clothes manufacturer, and a body size measurement model may be trained using the information.

According to the present invention, an established body size measurement model may be provided to an online shopping mall, and when the user selects specific clothes, a size suitable for the user may be provided.

The technical problems solved by the embodiments are not limited to the above technical problems and other technical problems which are not described herein will become apparent to those skilled in the art from the following description.

### Technical Solution

According to an embodiment of the present invention, a method of measuring a body size and recommending a clothes size using an image, performed by a server includes measuring a body size of a user from a user image captured from a user terminal using a body size measurement model, providing the measured body size of the user to a customized clothes manufacturer for manufacturing customized clothes ordered by the user, receiving information on a fitting or basting result of the ordered customized clothes of the user, from the customized clothes manufacturer, and training the body size measurement model using the information.

The method may further include providing a size recommendation function to the server and an affiliated online shopping mall using the body size measurement model.

The providing the size recommendation function may include measuring the body size of a member of the online shopping mall from the user image acquired from a mobile device of the member using the body size measurement model, upon selecting the size recommendation function on a page of a specific product in the online shopping mall from the member, matching an actual size of the specific product with the measured body size of the member, and recommending a size of the specific product to the member as a matching result.

The measuring the body size of the member may include, when the member of the online shopping mall is a service subscriber of the server, checking user information and loading the body size of the user stored in a database.

The method may further include receiving information on a fitting result of the specific product from the member ordering the specific product, and training the body size measurement model using the information on the fitting result of the specific product.

The recommending the size may include recommending the size of the specific product to the member in consideration of a fitting style of the specific product input from the member.

The measuring the body size may include an image acquisition operation of acquiring front and side images of the user, captured through a photographing device of the user terminal, the image being captured in a state in which a body of the user in a photographing screen of the user terminal is positioned in a range of a guideline displayed on the photographing screen of the user terminal.

The guideline may induce the user to take a specific posture at a specific distance from the user terminal and may have a shape of a front or a side of a human body, a front guideline has a shape with a user's arm extended at a predetermined angle from a torso and both user's legs separated by a predetermined angle, and the server may adjust a shape and size of the guideline in consideration of information of a body of the user.

The measuring the body size may include recognizing a region corresponding to a body of the user from the front and side images of the user, separating an edge of the recognized region from a background, and extracting the edge, analyzing the extracted edge and selecting a 3D standard body model corresponding to the edge, by an image analysis module, and acquiring the body size of the user using the selected 3D standard body model, wherein the image analysis module learns a method of generating the 3D standard body model using the front and side images of the body by inputting the front and side images and 3D images of the bodies of models having different physical conditions.

The method may further include, subsequent to the selecting the 3D standard body model, correcting the selected 3D standard body model in consideration of at least one of an analysis result of information of the body of the user or an analysis result of the edge, by the image analysis module, wherein the image acquisition operation may include acquiring the body size of the user using the corrected 3D standard body model.

According to another embodiment of the present invention, a server for measuring a body size and recommending a clothes size using an image includes a measurer configured to measure a body size of a user from a user image captured from a user terminal using a body size measurement model, an information provision unit configured to provide the measured body size of the user to a customized clothes manufacturer for manufacturing customized clothes ordered by the user, and a learning module configured to, upon receiving information on a fitting or basting result of the ordered customized clothes of the user, from the customized clothes manufacturer, train the body size measurement model using the information.

In addition, another method, and another system for implementing the present invention, and a computer readable recording medium for recording a computer program for executing the method may be further provided.

### Effect of Invention

According to the present invention, a body size of a user may be measured from an image of the user, captured from a user terminal, and thus the user may measure an accurate body size using a camera of a general mobile device in a house.

According to the present invention, the aforementioned measured body size of the user may be provided to a customized clothes manufacturer, and thus, customized clothes may be manufactured with accurate dimensions.

According to the present invention, information on a fitting or basting result of customized clothes of a user may be received from a customized clothes manufacturer, and thus an error of a body size measurement model may be checked, and the body size measurement model may be trained, thereby improving accuracy.

According to the present invention, an established body size measurement model may be provided to an online shopping mall, and when a user selects specific clothes, a size suitable for a body of the user may be recommended.

It will be appreciated by persons skilled in the art that that the effects that could be achieved with the present invention are not limited to what has been particularly described hereinabove and other advantages of the present invention will be more clearly understood from the detailed description.

### BRIEF DESCRIPTION OF DRAWINGS

FIG. 1 is a schematic diagram of a system 10 for measuring a body size and recommending a clothes size using an image according to an embodiment of the present invention.

FIGS. 2 and 3 are flowcharts of a method of measuring a body size and recommending a clothes size using an image according to an embodiment of the present invention.

FIG. 4 is a flowchart showing an example of an operation of measuring a body size of a user in FIG. 2 in more detail.

FIG. 5 is a diagram showing an example of a guideline displayed on a photographing screen of a user terminal in an image acquisition procedure.

FIG. 6 is a diagram showing an example in which a user photographs a body using a terminal.

FIG. 7 is a diagram showing an example of a 3D standard body model of a user selected by an image analysis module using a captured image of a user.

FIG. 8 is a diagram showing an example of a measurement result of each size of a body part of a user using a captured image of a user.

FIG. 9 is a block diagram of a server for measuring a body size and recommending a clothes size using an image according to an embodiment of the present invention.

### BEST MODE

The attached drawings for illustrating exemplary embodiments of the present invention are to be referred to in order to gain a sufficient understanding of the present invention, the merits thereof, the objectives accomplished by the implementation of the present invention, and a method of achieving the same. The present invention may, however, be embodied in many different forms, and should not be construed as being limited to the embodiments set forth herein; rather, these embodiments are provided so that this disclosure will be thorough and complete, and will fully convey the concept of the present invention to one of ordinary skill in the art.

Terms used in this disclosure are used to describe specified embodiments and are not intended to limit the scope of another embodiment. The terms of a singular form may include plural forms unless otherwise specified. It will be further understood that the terms “comprises” and/or “comprising,” when used in this specification, specify the presence of stated components, but do not preclude the presence or addition of one or more other components. Like reference numerals in the drawings denote like elements, and the term “and/or” includes any and all combinations of one or more of the associated listed items. It will be understood that, although the terms first, second, third etc. may be used herein to describe various elements, these elements should not be limited by these terms. These terms are only used to distinguish one element from another element. Accordingly, a first element may be termed a second element without departing from the teachings of the present invention.

Unless otherwise defined, all terms including technical and scientific terms used herein have the same meaning as commonly understood by one of ordinary skill in the art to which this present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, an embodiment of the present invention will be described in detail with reference to the accompanying drawings.

Before the description, the meaning of the terms used in this specification will be briefly described. However, it should be noted that the description of terms is for the purpose of helping the understanding of the present specification, and is not used to limit the technical idea of the present invention unless explicitly described as limiting the present invention.

Basting: A process of checking whether tailored clothes are made to a user's body type at an intermediate stage.

Customized clothes: Clothes that are tailored to the style and size of a customer (user or consumer) by accurately identifying a body size of the customer.

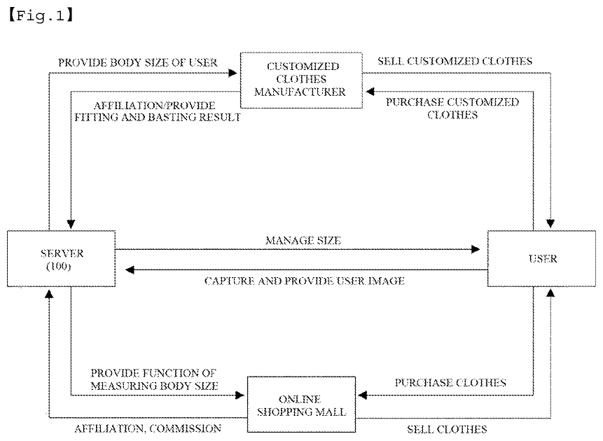

FIG. 1 is a schematic diagram of a system 10 for measuring a body size and recommending a clothes size using an image according to an embodiment of the present invention.

With reference to FIG. 1, the system 10 for measuring a body size and recommending a clothes size using an image will be outlined.

An embodiment of the present invention may be operated based on a server 100 and may be affiliated with a manufacturer and an online shopping mall of customized clothes.

The server 100 may provide a service application in order to acquire an image for measuring a body size of a user. A user may subscribe to the server 100, may install a service application in a terminal 300, may capture his or her body image, and may provide the body image to the server 100, and the server 100 may measure the body size of the user using a body size measurement model.

The body size of the user measured in this way may be provided to a customized clothes manufacturer and may also be used to produce customized clothes of the user.

The server 100 may provide the body size measurement model to an affiliated online shopping mall, and when the user purchases specific clothes, the server 100 may compare the corresponding clothes with the measured body size of the user and may recommend a size suitable for the user.

As such, the system 10 for measuring a body size and recommending a clothes size using an image according to an embodiment of the present invention may measure and manage the body size of the user using only an image of the user and may provide the body size of the user to an affiliated manufacturer and online shopping mall of customized clothes.

Hereinafter, embodiments of the present invention will be described in more detail with reference to other drawings.

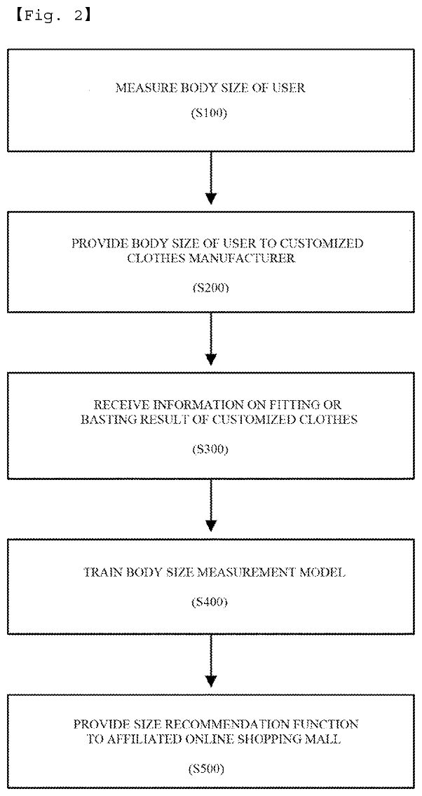

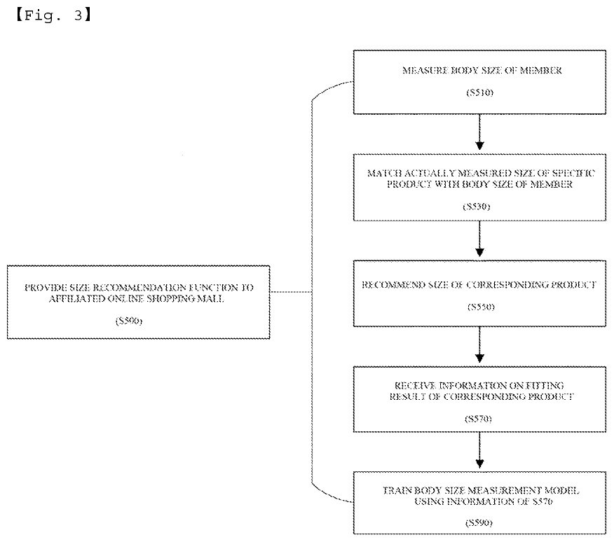

FIGS. 2 and 3 are flowcharts of a method of measuring a body size and recommending a clothes size using an image according to an embodiment of the present invention.

With reference to FIGS. 2 and 3, the method of measuring a body size and recommending a clothes size using an image according to an embodiment of the present invention will be described.

First, a measurer 110 may measure a body size of a user from a user image captured by the user terminal 300 using the body size measurement model (operation S100).

Although operation S100 will be described below in detail, operation S100 will now be briefly described.

According to an embodiment of the present invention, the user terminal 300 may refer to the terminal 300 having a 2D camera installed therein, such as a general mobile phone, a smartphone, or a tablet computer.

Conventionally, clothes are commonly purchased offline, but recently, clothes have been commonly purchased from online stores.

As such, it is determined that any user (consumer) who wants to purchase clothes needs to measure his or her body size without restrictions, and in this regard, a device for implementing this is a smartphone (mobile phone) that most people have nowadays.

In addition, since most smartphones of the present age do not have a professional function such as a 3D camera but have a 2D image photographing function, according to an embodiment of the present invention, the body size of the user may be measured based on the 2D image.

The measurer 110 of the server 100 may store the body size of the user measured in operation S100 in a database 180.

Subsequent to operation S100, an information provision unit 140 may provide the measured body size of the user to a customized clothes manufacturer in order to manufacture customized clothes ordered by the user (operation S200).

This means that the user places an order for customized clothes with the customized clothes manufacturer to manufacture customized clothes and the information provision unit 140 of the server 100 provides information on the body size of the user to the customized clothes manufacturer.

Accordingly, the user may visit the customized clothes manufacturer and may measure the body size more accurately, but may also use the body size received from the information provision unit 140 of the server 100.

The customized clothes manufacturer may produce customized clothes ordered using the body size of the user received from the information provision unit 140 of the server 100.

Subsequent to operation S200, the server 100 may receive information on the fitting or basting result of the ordered customized clothes of the user from the customized clothes manufacturer (operation S300).

Fitting of customized clothes may mean that a user tries on completely manufactured customized clothes after the customized clothes are completely produced, and basting of customized clothes may mean that whether customized clothes is properly made are checked in an intermediate stage.

Basting results may be changed depending on a situation of the customized clothes manufacturer, and thus the server 100 may receive the fitting result or the basting result.

In this case, the information received from customized clothes manufacturer by the server 100 may include information on whether customized clothes produced based on a body size accurately fit the user and information on a degree by which the customized clothes do not fit the user in the case in which the customized clothes do not fit the user, such as left arm 2 mm short or shoulder length 2 mm short.

Subsequent to operation S300, a learning module 150 of the server 100 may train a body size learning module using information received in operation S200 (operation S400).

As such, the server 100 may measure an accurate body size of the user from the image of the user using the body size measurement model and may provide the measured body size to the customized clothes manufacturer to facilitate of manufacture of customized clothes.

Whenever customized clothes are manufactured, the server 100 may receive information on the fitting or basting result of customized clothes and train the body size measurement model using the received information, thereby gradually improving the accuracy of measuring a body size.

According to an embodiment of the present invention, the server 100 may provide the body size measurement model to the server 100 and an affiliated online shopping mall.

In more detail, the server 100 may provide a size recommendation function to an affiliated online shopping mall using the body size measurement model (operation S500).

Thus, when a member (user) who uses an online shopping mall wants to browse the online shopping mall and purchase a specific product using the web or app and selects the size recommendation function, a size recommendation module 160 of the server 100 may recommend a suitable size for the user using the body size of the member (user) and an actual size of a corresponding product.

The size recommendation function provision operation S500 will be described in more detail with reference to FIG. 3.

The measurer 110 of the server 100 may measure a body size of a member of a user image acquired from a mobile device of the member of the online shopping mall using the body size measurement model (operation S510).

Operation S510 may be the same as operation S100 except for the member of the online shopping mall.

When the member of the online shopping mall is a subscriber of the service provided by the server 100 in operation S510, user information may be checked and a body size of the user, stored in the database 180, may be loaded (operation S515).

Accordingly, when the member of the online shopping mall is a subscriber of the service provided by the server 100 and has a history of measuring a body size, the body size of the user, stored in the database 180, may be loaded and may be used in the online shopping mall.

Accordingly, operation S510 may be replaced with operation S515 depending on whether the member of the online shopping mall subscribes to the server 100.

Subsequent to operation S510 or S515, when the member selects a size recommendation function on a page of a specific product in the online shopping mall, the size recommendation module 160 of the server 100 may match the actual size of the specific product with the body size of the member (user) (operation S530).

For example, when the clothes selected by the member (user) are a top, sizes such as neck circumference, chest width, waist circumference, arm length, and total length may be matched.

Subsequent to operation S530, as the matching result, the size recommendation module 160 of the server 100 may recommend a size of the specific product to the member (operation S550).

According to an embodiment of the present invention, the size may be recommended by matching the body size that is accurately measured using the body size measurement model with the actual size of the clothes, and thus the user may be capable of purchasing the corresponding size with confidence.

According to an embodiment, the server 100 may train the body size measurement model again using reviews (feedback) left by members (users) who purchased clothes using the size recommendation function on the online shopping mall.

In more detail, the server 100 may receive information on the fitting result of the specific product from the member who orders the specific product (operation S570).

The learning module 150 of the server 100 may train the body size measurement model using information on the fitting result of the specific product (operation S590).

Thus, the server 100 may train the body size measurement model using a real product purchase case, thereby further improving accuracy.

According to an embodiment, the server 100 may recommend the size of the specific product to the member in consideration of a fitting style of the specific product input from the member in the size recommendation operation S550.

In this case, the fitting style refers to whether to wear a perfect fit, such as skinny, regular size, semi-overfit, or overfit, whether to wear a regular size, whether to wear a little oversized, or whether to wear a large size, etc.

Accordingly, the size recommendation module 160 may match the measured body size of the user (member) and the actual size of the specific clothes to recommend a size of the clothes, and in this case, the size may be recommended down or up in consideration of the fitting style selected by the user.

As such, when the user wants to purchase clothes using a different fitting style instead of a regular size, the user may select the fitting style and may get recommendation on a size suitable for the fitting style.

According to an embodiment, the size recommendation module 160 of the server 100 may refer to size review information input by the member for one or more products, which are previously purchased on the online shopping mall, for size recommendation.

Accordingly, the size recommendation module 160 of the server 100 may compare the actual size of the clothes that were previously purchased by the member with the actual size of the member and may refer to evaluation of the corresponding member with respect to the size of the corresponding clothes, and thus the evaluation may be referred to for recommendation on the size of the specific clothes, thereby improving accuracy.

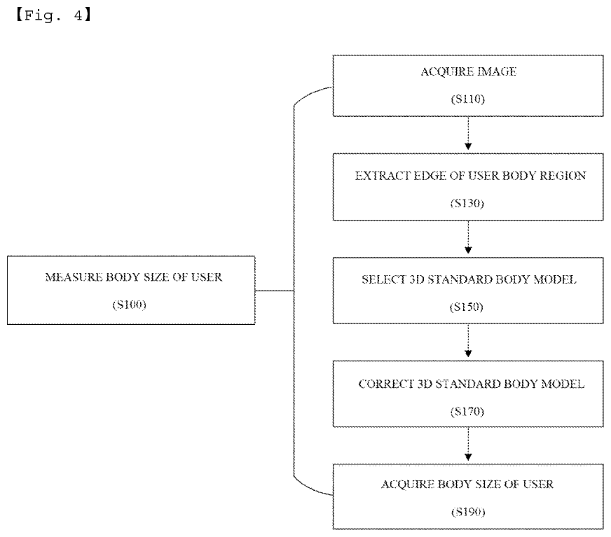

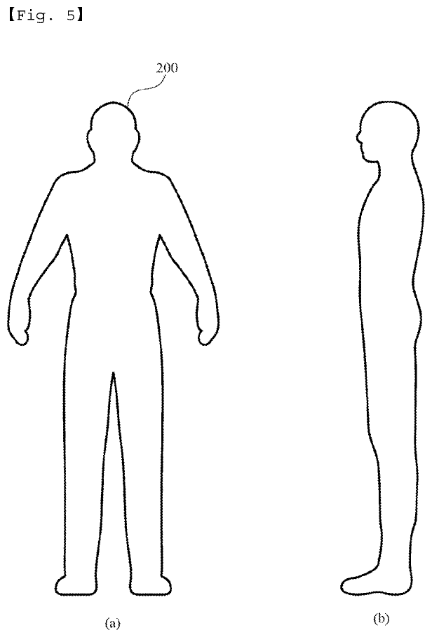

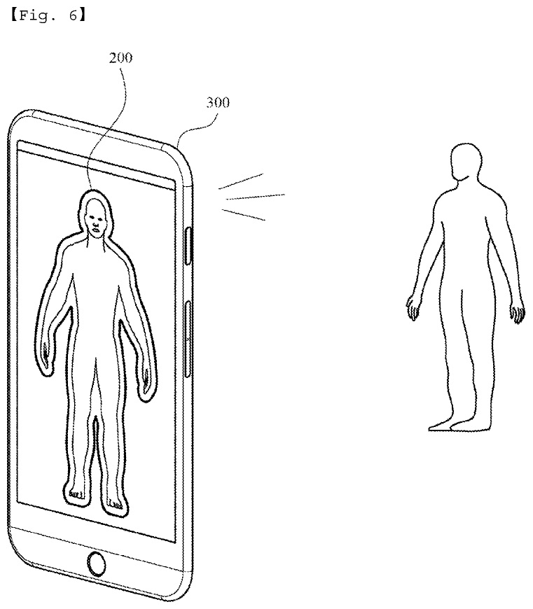

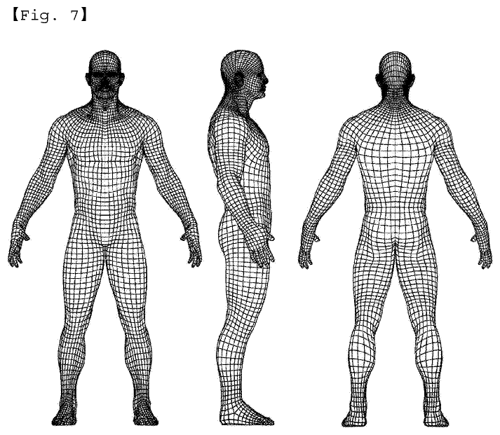

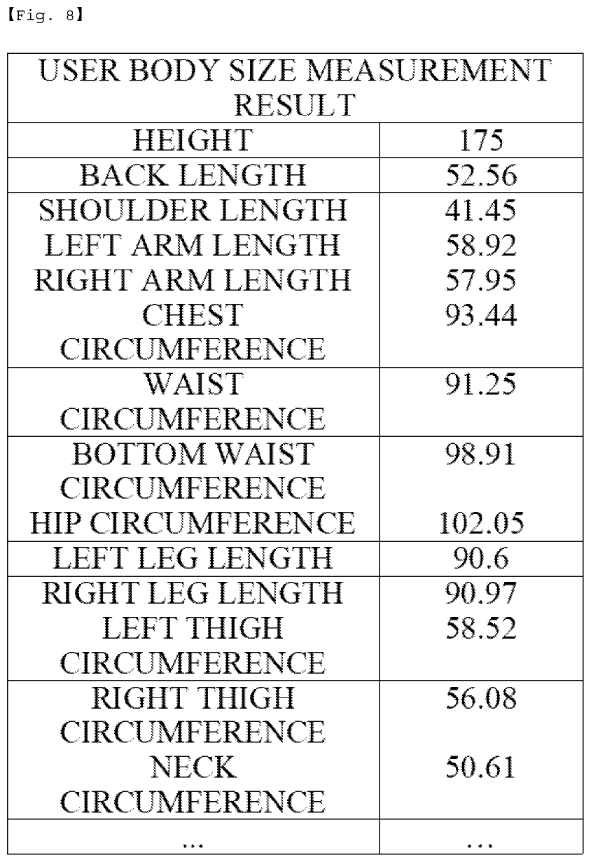

FIG. 4 is a flowchart showing an example of an operation of measuring a body size of a user in FIG. 2 in more detail. FIG. 5 is a diagram showing an example of a guideline 200 displayed on a photographing screen of the user terminal 300 in an image acquisition procedure. FIG. 6 is a diagram showing an example in which a user photographs a body using the terminal 300. FIG. 7 is a diagram showing an example of a 3D standard body model of a user selected by an image analysis module 130 using a captured image of the user. FIG. 8 is a diagram showing an example of the measurement result of each size of a body part of a user using a captured image of the user.

With reference to FIGS. 4 to 8, the operation S100 of measuring the body size of the user will be described in more detail.

The server 100 may capture front and side images of the user, captured through a photographing device of the user terminal 300 (operation S110).

In this case, the image may be captured in the state in which the body of the user on the photographing screen of the user terminal 300 is positioned in a range of the guideline 200 displayed on the photographing screen of the user terminal 300.

According to an embodiment, the guideline 200 may induce the user to take a specific posture at a specific distance from a user terminal, may have a front or side shape of the human body, the front guideline 200 may induce the user to open the user's arm at a predetermined angle from the torso and to open both arms at a predetermined angle, and the server 100 may adjust the shape and size of the guideline 200 in consideration of information on the body of the user.

In more detail, first, a guide provision module 115 of the server 100 may display the guideline 200 on the photographing screen of the user.

In addition, an image acquisition module 120 of the server 100 may acquire front and side images of the user, photographed by a photographing device of the terminal 300 of the user.

Referring to FIG. 5, the front and side images of the user, acquired by the image acquisition module 120 of the server 100, may be captured in the state in which the body of the user being photographed is positioned in a range of the guideline 200 on the photographing screen of the terminal 300.

In this case, the guideline 200 may be displayed on the photographing screen of the terminal 300 and may induce the user to take a specific posture at a specific distance from the terminal 300 to contain the body of the user within the guideline 200. (When the guideline 200 is displayed on the photographing screen of the terminal 300, this means that the guideline 200 is displayed to overlap with the photographing screen of the terminal 300.)

As described above, the server 100 according to an embodiment of the present invention may provide a service application stored in a medium for executing a method according to an embodiment of the present invention.

Accordingly, hereinafter, according to an embodiment of the present invention, when an operation is performed by the terminal 300, this immediately means that the operation is performed through the service application.

When the user executes the service application and activates a photographing function, a camera of the terminal 300 may be activated and the photographing screen may be turned on, as shown in FIG. 6. The service application may display the guideline 200 on the photographing screen of the terminal 300 as pre-programed.

In this case, according to an embodiment of the present invention, display of the guideline 200 on the photographing screen may be programmed by the guide provision module 115 in the service application provided by the server 100, and whenever the service application is driven, the guide provision module 115 of the server 100 may control display of the guideline 200 on the photographing screen.

The implementation of the guide provision module 115 may be easily selected according to a situation by an implementer of the invention.

When the user installs and drives the service application in order to measure a body size, the guide provision module 115 may display the guideline 200 on the photographing screen of the terminal 300 through the service application.

FIG. 5A is a diagram showing an example of a front guideline 200 for capturing a front image of the body to a user. FIG. 5B is a diagram showing an example of a side guideline 200 for capturing a side image of the body.

The user may visually check the front guideline 200 displayed on the photographing screen of the terminal 300 and may adjust the posture to position the body in the guideline 200, as shown in FIG. 6, and the guide provision module may detect that the user's body is exactly positioned in the guideline 200 to capture an image of the user.

When determining that the front image of the user is properly acquired, the guide provision module 115 may display the side guideline 200 on the photographing screen of the terminal 300 to induce the user to change their posture, and upon determining that a side of the body of the user is positioned in the guideline 200, the guide provision module 115 may acquire the side image of the user.

In this case, the server 100 may automatically capture and acquire the image of the user when the posture of the user is taken as described above, but may acquire the image of the user using various methods including a method of capturing the image by setting a timer, a method of capturing the image by clicking a photographing button by another user, and a method of capturing the image through remote adjustment of the user.

An order in which the server 100 acquires the front and side images is not limited, and the number of images for acquiring the front or side image may also be changed according to embodiments of the present invention.

For example, the image acquisition module 120 of the server 100 may acquire both left and right side images of the user or may acquire only one side image.

The guideline 200 may have such a shape because, when the user's arm is attached to the torso, it is difficult to separate the arm and the torso on the image and many errors occur in this process.

In addition, this is because, when an angle between the user's arm and torso is set to be excessively large in this process, it is difficult to separate the user's torso and arm from the shoulder part on the image and errors occur again in this process.

Accordingly, the server 100 according to an embodiment of the present invention may provide and display the guideline 200 based on an algorithm calculated to accurately measure a body size of the user using front and side images later, not only for inducing the user to take a specific posture at a specific distance from the terminal 300 by displaying the guideline 200.

According to an embodiment, for this implementation, the server 100 may receive information on the height and weight of the user through the terminal 300 and may adjust the shape and size of the guideline 200 in consideration of the received information.

Accordingly, the server 100 may adjust an arm angle of the guideline 200 in consideration of the user's body information input through the terminal 300.

In more detail, the server 100 may set the width and thickness of the guideline 200 wider and may adjust and increase the angle between the arm and the torso as the weight input from the user is higher.

For example, this is because, if a person weighing 100 kg stands with his or her arms spread apart from the torso in the same way as a person weighing 45 kg, the torso and the arms overlap due to the thickness of the torso and the arms.

In addition, in the case of a user who weighs more than the average, an error may occur because the body exceeds the guideline 200, and accordingly, for users whose weight exceeds a standard range, the guideline 200 may be corrected and displayed on the photographing screen.

The present applicant found that most people with normal typical body conditions were accurately photographed and a body size was also accurately photographed but it was somewhat difficult to position the body within a guideline on a photographing screen in the case of people who do not have a standard physical condition during photography using the guideline 200 and an experiment for measuring a body size, and accordingly, obtained the above solution.

As described above, the server 100 may acquire an image for measuring the body size of the user.

Subsequent to operation S110, an edge extractor 125 of the server 100 may recognize a region corresponding to the body of the user from the front and side images of the user and may separate an edge of the recognized region from a background and may extract the edge (operation S130)

In more detail, the front and side images of the user may be acquired using the guideline 200, but since the corresponding image contains a background in addition to the body of the user, the edge extractor 125 may extract an edge part corresponding to the body of the user region from the background in order to measure the body size of the user.

In this case, the edge extractor 125 may recognize that the body of the user is positioned in the guideline 200 on the image, and thus accuracy in the current case may be greatly improved compared with the case in which an edge of the user body is extracted from a general image.

According to an embodiment, operation S130 may further include an operation of determining an image of clothes that the user wears as noise from the body of the user recognized in operation S130 by the edge extractor 125.

An ideal photographing method is a method of capturing front and side images in the state in which a user wears clothes that clearly show an outline of the body, but if the user wears clothes that do not clearly show an outline of the body, a process of determining the image of the clothes as noise and removing the image may be performed as described above.

Subsequent to operation S130, the image analysis module 130 may analyze the edge extracted in operation S130 and may select a 3D standard body model corresponding thereto (operation S150)

In this case, by inputting front and side images and 3D images of bodies of models having different physical conditions, the image analysis module 130 may learn a method of generating a 3D standard body model using the front and side images of the bodies.

In more detail, the image analysis module 130 may learn a method of generating the 3D standard body model upon receiving front and side images of a specific user by inputting front and side images and 3D images of models who wear clothes that clearly show an outline of the body, and such training may be performed multiple times (hundreds or thousands of times) through images of models with different physical conditions, thereby ensuring accuracy.

Through this process, the image analysis module 130 may select the 3D standard body model of the user as shown in FIG. 7.

According to an embodiment, when the server 100 fails to recognize a region corresponding to the user's body in the image or the extracted edge does not correspond to a normal body shape, the server 100 may request rephotographing to the user after posture correction or after changing clothes.

In more detail, as described above, when recognition of the region corresponding to the user's body fails or the extracted edge does not correspond to the normal body shape, it may be determined that a user posture for photographing is not appropriate or the user is wearing clothes that are difficult to recognize by a computer, and rephotographing after posture correction may be requested to the user or rephotographing after changing clothes may be requested to the user.

Subsequent to operation S150, in consideration of at least one of the analysis result of information on the body of the user or the analysis result of the extracted edge, the image analysis module 130 may correct the 3D standard body model selected in operation S150 (operation S170).

In more detail, the 3D standard body model selected by the image analysis module 130 in operation S150 may be corrected to a user-optimized 3D model in consideration of at least one of the analysis result of information on the body of the user or the analysis result of the extracted edge.

Accordingly, the 3D standard body model corrected in operation S170 may more precisely correspond to the body of the user than the 3D standard body model selected in operation S150.

The objective of the present invention is to measure a body size using a 2D camera of the terminal 300 without use of a technical photographing device such as a 3D photographing device.

In this case, since the image analysis module 130 is trained through numerous models, a sufficiently accurate 3D standard body model is generated using only an extracted edge, but other conditions other than edge information extracted from a 2D image are not involved, and accordingly, accuracy needs to be further improved.

Accordingly, the analysis result of information on the body of the user (e.g., height, weight, body condition, or body peculiarities) and the analysis result of the edge are used during various tests, thereby further improving accuracy.

As such, according to the present invention, the selected 3D standard body model may be corrected using the analysis result of information on the body of the user and the analysis result of the edge, thereby obtaining a more accurate result.

Subsequent to operation S170, a calculator 135 may acquire the body size of the user using the 3D standard body model or the corrected 3D standard body model (operation S190).

The corrected 3D standard body model may be acquired from the 2D image of the user through the aforementioned operations, and thus the calculator 135 may be capable of acquiring the size of all body parts of the user using the corrected 3D standard body model.

FIG. 8 is a diagram showing an example of acquiring body sizes of various body parts of a user using a 3D standard body model or a corrected 3D standard body model.

Conventionally, in the case of tops, only fragmentary actual size information, such as a chest size, a full length, and an arm length, may be provided, and in the case of bottoms, only fragmentary actual size information, such as a full length, a hem width, a waist circumference, and a thigh circumference, may be provided.

In this method, an error occurs in many cases because the user has to measure the body size of the user himself or herself, resulting in failure to select the size in many cases.

However, when the present invention described above is used, it may be possible to ensure accurate data of the body of the user to select an accurate size by forming an accurate 3D standard body model of the user.

Also, it may be possible to accurately calculate the sizes of all body parts of the user using the 3D standard body model and to also fit the user for the clothes virtually, in reality.

According to an embodiment, the server 100 may ask a user accessing the server 100 to input information on whether the weight has changed at regular intervals, and when there is a change in the user's weight by more than a critical ratio, the body size of the user may be acquired again using a first method of requesting rephotographing to the user or a second method of recorrection of the corrected 3D standard body model in consideration of the weight change of the user.

For example, in the state in which a critical ratio of 10% is set in the server 100 and the 3D standard body model corrected when the weight of the user is 60 kg, if the weight input from the user after 5 months is 68 kg, the weight may exceed a critical ratio of 10%.

Thus, the server 100 may respond to the weight change of the user by acquiring the body size of the user again using the aforementioned first or second method, and thus, even if the weight of the user is changed, the body size may be acquired again depending on the change.

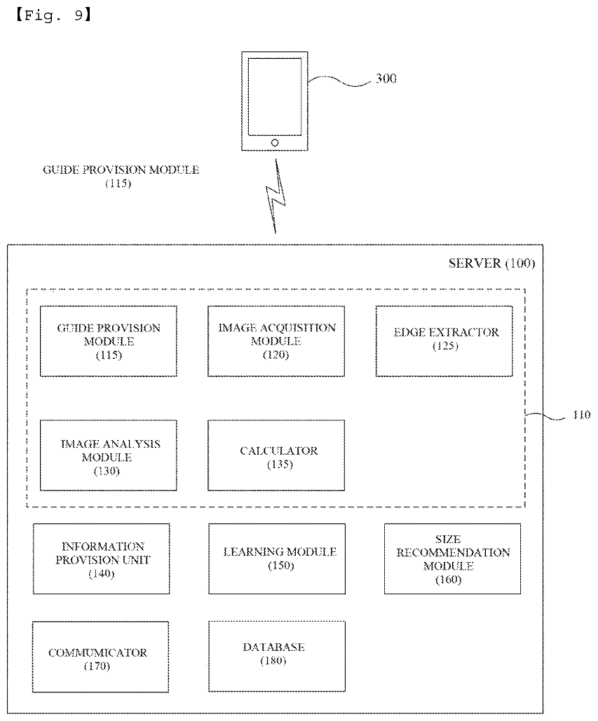

FIG. 9 is a block diagram of the server 100 for measuring a body size and recommending a clothes size using an image according to an embodiment of the present invention.

With reference to FIG. 9, the server 100 for measuring a body size and recommending a clothes size using an image according to an embodiment of the present invention will be described.

The server 100 may include the measurer 110, the information provision unit 140, the learning module 150, a size recommendation module 160, a communicator 170, and the database 180.

However, in some embodiments, the server 100 may include greater or fewer components than those of FIG. 9.

The measurer 110 may measure the body size of the user from the captured 2D image of the user from the user terminal 300 using the body size measurement model.

The measurer 110 may include the guide provision module 115, the image acquisition module 120, the edge extractor 125, the image analysis module 130, and the calculator 135.

The information provision unit 140 may provide the measured body size of the user to a customized clothes manufacturer in order to manufacture customized clothes ordered by the user.

Upon receiving information on the fitting or basting result of the customized clothes ordered by the user from the customized clothes manufacturer, the learning module 150 may train the body size measurement model using the information.

When a member who uses an online shopping mall wants to browse the online shopping mall and purchase a specific product using a web or an app and selects the size recommendation function, the size recommendation module 160 may recommend a suitable size for the user using the body size of the corresponding member and an actual size of a corresponding product.

The database 180 may store information on a user and a member, information on the body, information on a measured body size, etc.

The communicator 170 may communicate with the terminal 300 of the user, a customized clothes manufacturer, an online shopping mall, etc. by wire or wirelessly.

The server 100 for measuring a body size and recommending a clothes size using an image according to the aforementioned embodiment of the present invention may be understood by the same description as the method of measuring a body size and recommending a clothes size using an image, which have been described with reference to FIGS. 1 to 8, while only the categories are different, and thus repeated descriptions and examples are omitted.

The aforementioned method according to an embodiment of the present invention may be implemented as a program (or application) to be executed in combination with a server, which is hardware, and stored in a medium.

The aforementioned program may include code in a computer language such as C, C++, JAVA, or machine language, which is readable through a device interface of a computer, in order for the computer to read the program and to execute the methods implemented as a program. The code may include functional code related to a function defining functions necessary for executing the methods, etc. and may include execution procedure related control code necessary for the processor of the computer to execute the functions according to a predetermined procedure. In addition, the code may further include additional information necessary for the processor of the computer to execute the functions or code related to reference of a memory, for which location (address) in the internal or external memory of the computer is to be referenced. In addition, when the processor of the computer needs to communicate with any other computer or server located remotely in order to execute the above functions, the code may further include communication related code for a method of communication with any other computers or servers using the communication module of the computer or information or media to be transmitted or received during communication.

The stored media are not media that store data for a short moment, such as a register, cache, memory, etc., but are media that semi-permanently store data, and mean a medium that can be read by a device. In detail, examples of the stored media may include, but are not limited to, ROM, RAM, CD-ROM, magnetic tape, floppy disks, and optical data storage devices. That is, the program may be stored in various recording media on various servers accessible by the computer or in various recording media on the computer of the user. In addition, the media may be distributed in a computer system connected by a network, and computer-readable code may be stored in a distributed manner.

The operations of the method or algorithm described in relation to the embodiment of the present invention may be implemented directly in hardware, implemented as a software module executed by hardware, or a combination thereof. The software module may always be stored in random access memory (RAM), read only memory (ROM), erasable programmable ROM (EPROM), electrically erasable programmable ROM (EEPROM), flash memory, a hard disk, a removable disk, a CD-ROM, or any type of computer-readable recording medium that is well known in the art.

As mentioned above, although embodiments of the present invention have been described with reference to the accompanying drawings, those skilled in the art to which the present invention pertains are capable of implementing the present invention in other specific forms without changing the technical spirit or essential features thereof. Therefore, it should be understood that the embodiments described above are illustrative in all respects and not restrictive.

Description of reference numerals

10: system for measuring body size and recommending
clothes size using image

| | | | |
|---|---|---|---|
| 100: | server | 110: | measurer |
| 115: | guide provision module | 120: | image acquisition module |
| 125: | edge extractor | 130: | image analysis module |
| 135: | calculator | 140: | information provision unit |
| 150: | learning module | 170: | communicator |
| 180: | database | 200: | guideline |
| 300: | user terminal | | |

1. A method of measuring a body size and recommending a clothes size using an image, performed by a server, the method comprising:
measuring a body size of a user from a user image captured from a user terminal using a body size measurement model;
providing the measured body size of the user to a customized clothes manufacturer for manufacturing customized clothes ordered by the user;
receiving information on a fitting or basting result of the ordered customized clothes of the user, from the customized clothes manufacturer; and
training the body size measurement model using the information.

2. The method according to claim 1, further comprising:
providing a size recommendation function to the server and an affiliated online shopping mall using the body size measurement model.

3. The method according to claim 2, wherein the providing the size recommendation function includes:
measuring the body size of a member of the online shopping mall from the user image acquired from a mobile device of the member using the body size measurement model;
upon selecting the size recommendation function on a page of a specific product in the online shopping mall from the member, matching an actual size of the specific product with the measured body size of the member; and
recommending a size of the specific product to the member as a matching result.

4. The method according to claim 3, wherein the measuring the body size of the member includes:
when the member of the online shopping mall is a service subscriber of the server, checking user information and loading the body size of the user stored in a database.

5. The method according to claim 3, further comprising:
receiving information on a fitting result of the specific product from the member ordering the specific product; and
training the body size measurement model using the information on the fitting result of the specific product.

6. The method according to claim 3, wherein the recommending the size includes recommending the size of the specific product to the member in consideration of a fitting style of the specific product input from the member.

7. The method according to claim 1, wherein the measuring the body size includes:
an image acquisition operation of acquiring front and side images of the user, captured through a photographing device of the user terminal, the image being captured in a state in which a body of the user in a photographing screen of the user terminal is positioned in a range of a guideline displayed on the photographing screen of the user terminal.

8. The method according to claim 2, wherein:
the guideline induces the user to take a specific posture at a specific distance from the user terminal and has a shape of a front or a side of a human body;
a front guideline has a shape with a user's arm extended at a predetermined angle from a torso and both user's legs separated by a predetermined angle; and
the server adjusts a shape and size of the guideline in consideration of information of a body of the user.

9. The method according to claim 2, wherein the measuring the body size includes:
recognizing a region corresponding to a body of the user from the front and side images of the user, separating an edge of the recognized region from a background, and extracting the edge;
analyzing the extracted edge and selecting a 3D standard body model corresponding to the edge, by an image analysis module; and
acquiring the body size of the user using the selected 3D standard body model,
wherein the image analysis module learns a method of generating the 3D standard body model using the front and side images of the body by inputting the front and side images and 3D images of the bodies of models having different physical conditions.

10. The method according to claim 9, further comprising:
subsequent to the selecting the 3D standard body model, correcting the selected 3D standard body model in consideration of at least one of an analysis results of information of the body of the user or an analysis result of the edge, by the image analysis module,
wherein the image acquisition operation includes acquiring the body size of the user using the corrected 3D standard body model.

11. A server for measuring a body size and recommending a clothes size using an image, the server comprising:
a measurer configured to measure a body size of a user from a user image captured from a user terminal using a body size measurement model;
an information provision unit configured to provide the measured body size of the user to a customized clothes manufacturer for manufacturing customized clothes ordered by the user; and
a learning module configured to, upon receiving information on a fitting or basting result of the ordered customized clothes of the user, from the customized clothes manufacturer, train the body size measurement model using the information.

12. A non-transitory computer readable recording medium for storing a program for measuring a body size and recommending a clothes size using an image, the program instructing a computer to execute the method according to claim 1.
